(19) United States
(12) Patent Application Publication
(10) Pub. No.: US 2023/0383889 A1
(43) Pub. Date: Nov. 30, 2023

(54) PLASTIC CAP PIPE FITTING

(71) Applicant: Tyco Fire Products LP, Cranston, RI (US)

(72) Inventor: Steven L. Shields, Lubbock, TX (US)

(73) Assignee: Tyco Fire Products LP, Cranston, RI (US)

(21) Appl. No.: 18/247,220

(22) PCT Filed: Dec. 3, 2021
(86) PCT No.: PCT/IB2021/061331

§ 371 Date: Mar. 29, 2023

Related U.S. Application Data
(60) Provisional application No. 63/122,576, filed on Dec. 8, 2020.

(51) Int. Cl. F16L 55/115

(52) U.S. Cl. CPC F16L 55/1152

(57) ABSTRACT

A fire protection system can include one or more pipes coupled with a fluid source, a pipe fitting coupled with the one or more pipes downstream of the fluid source, and at least one sprinkler coupled with the one or more pipes and the pipe fitting. The pipe fitting can include a wall defining an opening, the wall having an outer diameter, a first wall thickness at the opening, and a second wall thickness inward from the opening, the second wall thickness greater than the first wall thickness. The at least one sprinkler can be coupled with the one or more pipes and the pipe fitting to receive fluid from the fluid source through the one or more pipes and the pipe fitting.

### CROSS-REFERENCE TO RELATED APPLICATIONS

The present disclosure claims the benefit of and priority to U.S. Provisional Application No. 63/122,576, titled “PLASTIC CAP PIPE FITTING,” filed Dec. 8, 2020, the disclosure of which is incorporated herein by reference in its entirety.

### BACKGROUND

Cap pipe fittings can be connected to pipes and fittings and are used to halt the flow of fluid, wherein fluid can include liquid and gas. As such, cap pipe fittings can experience great fluctuations in pressure (water hammer).

### SUMMARY

At least one aspect relates to a cap fitting comprising a socket and an end wall. The socket can be defined by a first end and a second end. The first end can be an opening. The socket can have an outer diameter. The socket can further have a first wall thickness at the first end and a second wall thickness at the second end. The second wall thickness can be greater than the first wall thickness. The end wall can be coupled with the second end of the socket. The end wall can have a third wall thickness greater than the second wall thickness. The end wall can have a concave shape such that there is a linear transition between an internal surface of the socket and an internal surface of the end wall.

At least one aspect relates to a method of assembly of a cap pipe fitting. The method comprising providing a socket and coupling an end wall with a second end of the socket. The socket defining a first end and a second end. The first end being an opening. The socket having an outer diameter. The socket further having a first wall thickness at the first end and a second wall thickness at a second end. The second wall thickness being greater than the first wall thickness.

At least one aspect relates to a method of manufacture of a cap pipe fitting. The method comprising providing a cap pipe fitting. The cap pipe fitting comprising a socket and an end wall. The socket can be defined by a first end and a second end. The first end can be an opening. The socket can have an outer diameter. The socket can further have a first wall thickness at the first end and a second wall thickness at the second end. The second wall thickness can be greater than the first wall thickness. The end wall can be coupled with the second end of the socket. The end wall can have a third wall thickness greater than the second wall thickness. The end wall can have a concave shape such that there is a linear transition between an internal surface of the socket and an internal surface of the end wall.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of a cap pipe fitting assembly.

FIG. 2 is a schematic diagram of a cap pipe fitting.

FIG. 3 is a flow chart of a method of assembling a cap pipe fitting.

FIG. 4 is a flow chart of a method of manufacture of a cap pipe fitting.

### DETAILED DESCRIPTION

Following below are more detailed descriptions of various concepts related to, and implementations of cap pipe fittings, assemblies, systems, and methods. Cap pipe fittings can be used to halt the flow of a fluid through a pipe or pipe fitting (e.g., tee). The various concepts introduced above and discussed in greater detail below can be implemented in any of numerous ways.

Piping systems can be installed in various locations, such as buildings, in which fluid is delivered from a fluid source. The fluid can travel from a fluid source through one or more pipes, such as chlorinated polyvinyl chloride (CPVC) pipes. Pipe fittings can connect the one or more pipes with one another so that fluid can be delivered from the fluid source and through a building including but not limited to residential piping systems such as for low-rise, one and two family dwelling, and manufactured homes. A cap pipe fitting can be used in the piping system for any of a number of reasons. For example, a plumber can provide a segment of pipe off of a tee fitting to allow for future supply of fluid in a particular direction. To allow for the functioning of the remainder of the piping system before the remainder of the piping system is installed, a cap pipe fitting can be installed thus halting the flow of fluid in the segment of pipe. Cap pipe fittings can further be utilized in a number of other configurations.

In various piping systems, the cap pipe fittings can be coupled to the pipes using a solvent-cement (e.g., to perform chemical welding). The cap pipe fittings can be coupled to the pipes using corresponding threads between the socket and the pipe. Some cap pipe fittings are designed to comply with ASTM specifications, such as ASTM sizing specifications for pipe fittings. For example, pipe fittings can be designed to comply with the ASTM F438 Standard Specification for Socket-Type CPVC Plastic Pipe fittings, Schedule 40 (e.g., Schedule 40 iron pipe size (IPS)) and ASTM F439 Standard Specification for Socket-Type CPVC Plastic Pipe Fittings, Schedule 80 (e.g., Schedule 80 iron pipe size (IPS)). For example, various such cap pipe fittings can have socket geometries and sizes, such as inner diameters, sized to receive the corresponding CPVC pipes (which can be attached using the solvent-cement). For example, the cap pipe fitting can have dimensions such as fitting wall thickness at the entrance of the socket (e.g., dimension E) that is matched to the pipe size (e.g., same minimum value) of the pipe wall thickness to be connected with the fitting.

The sizing of the cap pipe fittings can be made to ensure that the cap pipe fittings can withstand sufficient pressure (e.g., hydrostatic strength) to allow for fluid to be halted. For example, a cap pipe fitting can be made to ensure that the cap pipe fittings can withstand hydrostatic pressure cycling from 0 psi to 350 psi at a 6 second frequency for at least 10,000 cycles and a hydrostatic pressure of 875 psi for 60 seconds. In another example, a cap pipe fitting can be made to ensure that the cap pipe fittings can withstand hydrostatic pressure cycling from 0 psi to 450 psi at a 10 second frequency for at least 10,000 cycles and a hydrostatic pressure of 1000 psi for 60 seconds. In another example, a 1″ cap pipe fitting can be made to ensure that the cap pipe fitting can withstand a hydrostatic pressure of 1440 psi for a period of 60 to 70 seconds.

The cap pipe fitting or cap in accordance with the present disclosure can have hydrostatic strength to withstand hydrostatic pressure cycling from 0 psi to 350 psi at a 6 second frequency for at least 10,000 cycles followed by a hydrostatic pressure of 875 psi for 60 seconds with reduced material usage, such as by providing a concave end wall such that the transition between the socket and the end wall is linear (e.g., no defined corner). The transition between the socket and the end wall can also be nonlinear such that there is an internal stopper lip that can protrude between 1/15 inches and 1/40 inches. By creating a shape that can withstand greater pressures with less material, the present disclosure allows for more compact fittings (e.g., reduced diameter); and more efficient manufacturing, shipping, and storage. For example, by making the pipe fittings with less material, they can be shipped in greater quantities. Additionally, by providing a concave end wall such that the transition between the socket and the end wall is linear, the cap pipe fitting, as disclosed herein, can withstand greater pressures than standard cap pipe fittings and prevent against surges of pressure (e.g., water hammer) from fracturing the fitting. For example, the cap can have various dimensions as further described herein that can conform with schedule 40 or schedule 80 chlorinated polyvinyl chloride (CPVC) pipe which can withstand a minimum burst pressure of 1440 psi or 2020 psi, respectively, with a 1 inch size. The cap can further conform with pipe standards for polyvinyl chloride (PVC) schedule 40 and schedule 80 standards, CPVC and PVC SDR standards, etc. The cap is not limited to CPVC and PVC, the cap of the present disclosure can be applicable to other types of polymeric materials.

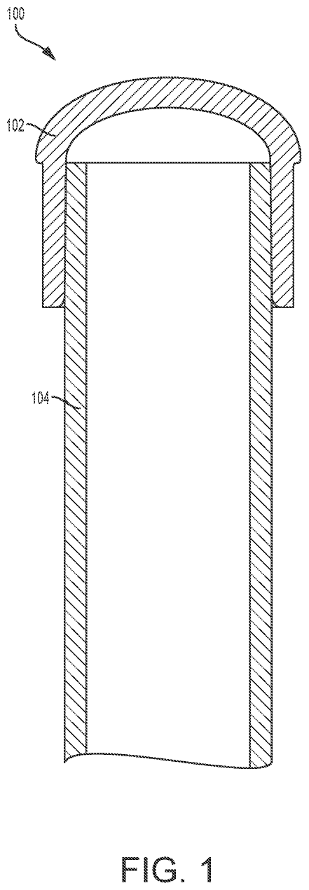

FIG. 1 depicts an example of a cap assembly 100. The cap assembly 100 can include a cap 102 and a pipe segment 104 or pipe 104. The pipe segment 104 can be connected to a piping system as described herein. The pipe segment 104 can include any of a variety of conduits that can be used to flow fluid, including but not limited to: piping, tubing, metal pipes, rigid pipes, or polymeric (e.g., chlorinated polyvinyl chloride (CPVC)) pipes. The pipe 104 can include thermoplastic pipes. The pipe segment 104 can be of various sizes (e.g. nominal sizes) including but not limited to: ¾ inch, 1 inch, 1.5 inch, 2 inch, 2.5 inch, and 3 inch pipe 104. The pipe segment 104 can further include additional pipe fittings such as, for example, street fittings (e.g., street tee fitting, street elbows), tees, reducing tees, elbows (e.g., 22.5°, 45°, 90°), reducing elbows, couplings, reducing couplings, crosses, reducing crosses, bushings, reducing bushings, grooved coupling adapters, or thread adapters with suitable connection structure (e.g., can be inserted, threaded).

The cap 102 can have various dimensions consistent with those for various standards, such as the Schedule 40 or Schedule 80 CPVC standards, enabling proper geometry for connecting with the pipe 104 (e.g., dimension A, dimension B, dimension C) while also allowing for the hydraulic performance improvements (e.g., greater hydrostatic pressure abilities compared to standard cap designs for use with the same size pipe 104).

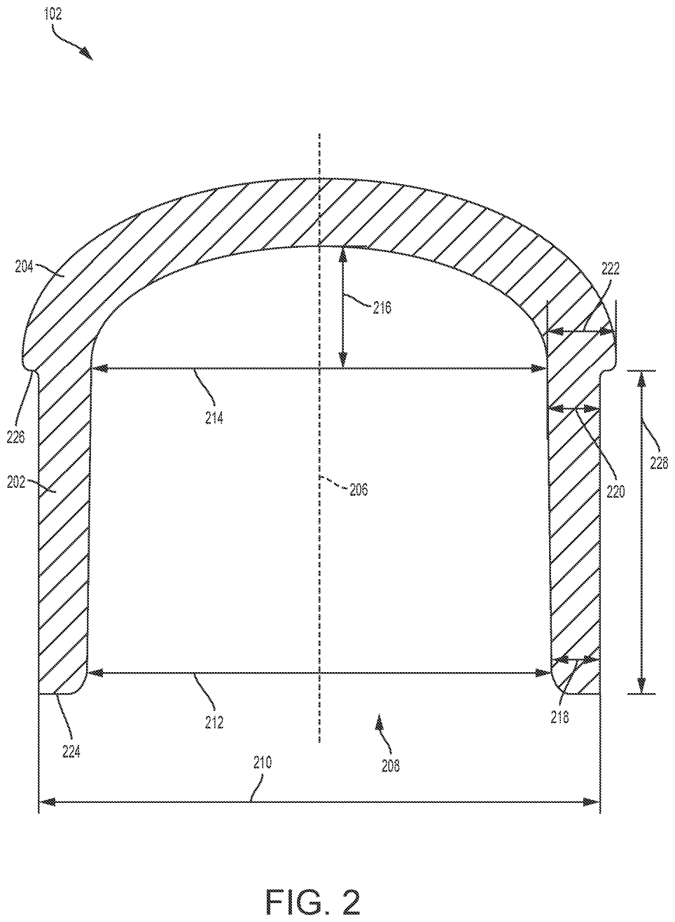

Referring now to FIG. 2, among others, a schematic diagram of a cap 102 is shown. The cap 102 includes a socket 202 and an end wall 204. The cap 102 can be symmetrical about a longitudinal axis 206. The socket 202 is defined by a first end 224 and a second end 226. The socket 202 defines an opening 208 in which a pipe 104 can be inserted. The socket 202 and the end wall 204 can be manufactured as a single piece (e.g., injection molded). The socket 202 and the end wall 204 can be manufactured as two individual pieces and coupled (e.g., ultrasonic weld). The cap 102 can be made of any suitable polymeric material (e.g., CPVC, PVC).

The socket 202 can have an outside diameter of 210. The outside diameter 210 can be constant from the first end 224 to the second end 226. The opening 208 can be defined by a first internal diameter 212 at the first end 224 and a second internal diameter 214 at the second end 226. The first internal diameter 212 can be a dimension A and the second internal diameter 214 can be a dimension B as described herein. The second internal diameter 214 can be less than the first internal diameter 212 providing a tapered inner surface of the socket 202. The second internal diameter 214 can also be equal to the first internal diameter 212 providing a constant inner surface of the socket 202.

The socket 202 can further have a first wall thickness 218 at the first end 224, and a second wall thickness 220 at the second end 226. The second wall thickness 220 can be greater than the first wall thickness 218. The first wall thickness can be a dimension E. The second wall thickness 220 can also be equal to the first wall thickness 218.

The internal surface of the socket 202 can be smooth to allow for chemical welding between the socket 202 and a pipe 104. The internal surface of the socket 202 can be threaded such that a threaded fitting or a threaded pipe with corresponding threads can be threaded into the cap. These are example configurations, and other configurations and internal surfaces of the socket 202 are possible. For example, the internal surface of the socket 202 can be barbed to allow a barbed fitting to be inserted into the opening 208.

An external surface of the socket 202 can be a smooth surface of the constant outside diameter 210. This is beneficial as it can minimize material required and the volume of the cap pipe fitting 102. The external surface of the socket 202 can have sections of radially symmetrical flat outer surfaces to allow an installer to use a tool (e.g., a wrench) to rotate the cap pipe fitting 102 around the longitudinal axis 206. This can be beneficial if the internal surface of the socket 202 is compatibly threaded with a pipe 104 such that the cap pipe fitting 102 must be rotated about the longitudinal axis 206 to be installed (e.g., threaded).

The socket 202 can be defined by a socket length 228. The socket length 228 can be a length between the first end 224 and the second end 226. The socket length 228 can be a dimension C, as described herein. The first end 224 of the socket 202 can have a radiused edge between the first end 224 and an internal surface of the socket 202. The first end 224 of the socket 202 can also have an angled edge (e.g., 15°, 30°, 45°, 60°) between the first end 224 and an internal surface of the socket 202.

The end wall 204 can be defined by the second internal diameter 214 and a third wall thickness 222. The third wall thickness 222 can be a dimension F, as described herein. The end wall 204 can be a concave shape such that a center of the end wall 204 that intersects with the longitudinal axis 206 is protruded outward away from the direction of the socket 202. A protrusion 216 can be a distance from a plane denoting the second end 226 of the socket 202 and an internal surface of the end wall 204 that intersects with the longitudinal axis 206.

The third wall thickness 222 can be a percentage of (e.g., 100-200% of) the first wall thickness 218. For example, the third wall thickness 222 can be 125% of the first wall thickness 218 such that the cap 102 can be a nominal 1 inch size cap fitting having the third wall thickness 222 of 0.148 inches and the first wall thickness 218 of 0.118 inches. The third wall thickness 222 can also be a percentage of (e.g., 100-200% of) the second wall thickness 220. For example, the third wall thickness 222 can be 130% of the second wall thickness 220 such that the cap 102 can be a nominal 1 inch size cap fitting having the third wall thickness 222 of 0.166 inches and the second wall thickness 220 of 0.128 inches.

The concave shape of the end wall 204 can be a semi-ellipse. The semi-ellipse can be defined by a major axis equal to the second internal diameter 214 and a minor axis equal to two times the protrusion 216. The concave shape can further be defined by a ratio of the major axis to the minor axis (e.g., 4:1, 3:1, 2:1, 1:1). For example, if the second internal diameter 214 is equal to 1.31 inches and the concave shape of the end wall 204 is defined by a 2:1 elliptical shape as defined above, the protrusion 216 can be 0.655 inches. In a further example, the end wall 204 can have a hemispherical shape such that the concave shape of the end cap is defined by a 1:1 elliptical shape, as defined above. For example, if the second internal diameter 214 is equal to 1.31 inches and the concave shape of the end wall 204 is defined by a 1:1 hemispherical shape as defined above, the protrusion 216 can be 1.31 inches.

The inner surface of the end wall 204 can have a planar area centered around the longitudinal axis 206 that is normal to the longitudinal axis 206. The planar area can be a circular area. The circular area can be sided such that the diameter of the planar circular area is not greater than a percentage (e.g., 25%, 50%, 75%) of the second internal diameter 214. For example, the end wall 204 can have a concave shape defined by a semi-ellipse with a 2:1 major axis to minor axis ratio with a circular planar portion with a diameter 25% of the second internal diameter 214 which is centered on the longitudinal axis 206. This can be beneficial as it can decrease the height of the cap pipe fitting 102 for use in confined spaces while providing a lesser stress concentration than traditional cap pipe fittings.

The transition between the internal surface of the socket 202 and the internal surface of the end wall 204 can be nonlinear such that there is an internal stopper lip that can protrude out (e.g., 1/15 inches, 1/32 inches, 1/60 inches). The transition between the internal surface of the socket 202 and the internal surface of the end wall 204 can also be linear. The linear transition defines that there is no abrupt transition between the internal surface of the socket 202 and the internal surface of the end wall 204. The linear transition can define that the point at which the internal surface of the socket 202 and the internal surface of the end wall 204 meet the internal surface of the socket 202 and the internal surface of the end wall 204 are tangent to the other. This is beneficial as by omitting an abrupt transition, there is no stress concentration that can promote fracture in a particular area. By eliminating the area of stress concentration, the cap 102 can maintain higher hydrostatic pressures, and pressure surges than standard cap designs.

The transition between the external surface of the socket 202 and the external surface of the end wall 204 can be an abrupt transition with rounded edges, as shown in FIG. 2. The transition between external surface of the socket 202 and the external surface of the end wall 204 can be abrupt with squared edges or chamfered edges. The transition can be a tapered transition such that the second wall thickness 220 is equal to the third wall thickness 222 and is tapered at an angle (e.g., 15°, 30°, 45°, 60°) until the outside diameter 210 is equal to the outside diameter 210 at the first end 224. This can be beneficial in high pressure applications due to the increased wall thickness near the transition between the socket 202 and the end wall 204.

An example cap 102 can be of standard dimensions for a schedule 40 CPVC fitting utilizing the standard dimensions as shown below.

| Nominal | First | Second | Minimum | Minimum | Minimum |
|---|---|---|---|---|---|
| Pipe | Internal | Internal | Socket | First Wall | Third Wall |
| Size | Diameter | Diameter | Length (C) | Thickness | Thickness |
| (in) | (A) 212 (in) | (B) 214 (in) | 228 (in) | (E) 218(in) | (F) 222 (in) |
| ½ | 0.848 | 0.836 | 0.688 | 0.109 | 0.136 |
| ¾ | 1.058 | 1.046 | 0.719 | 0.113 | 0.141 |
| 1 | 1.325 | 1.310 | 0.875 | 0.133 | 0.166 |
| 2 | 2.387 | 2.369 | 1.156 | 0.154 | 0.193 |
| 3 | 3.516 | 3.492 | 1.875 | 0.216 | 0.270 |

An example cap 102 can fit a 1″ schedule 40 CPVC pipe. The cap 102 can have a first internal diameter 212 of 1.325 inches, a second internal diameter 214 of 1.310 inches, a socket length 228 of 0.875 inches, a first wall thickness 218 of 0.133 inches, and a third wall thickness 222 of 0.166 inches. The shape of the end wall 204 can be a semi-ellipse with a ratio between the major axis and the minor axis of 2:1, thus having a protrusion 216 of 0.655 inches. Another example cap 102 can fit a 3″ schedule 40 CPVC pipe. The cap 102 can have a first internal diameter 212 of 3.516 inches, a second internal diameter 214 of 3.492 inches, a socket length 228 of 1.875 inches, a first wall thickness 218 of 0.216 inches, and a third wall thickness 222 of 0.270 inches. The shape of the end wall 204 can be a hemisphere with a ratio between the major axis and the minor axis of 1:1, thus having a protrusion 216 of 3.492 inches. These are examples, and the pipe 104 and the cap 102 can be made of a number of polymeric materials (e.g., PVC) and can be sized according to varying standards (e.g., schedule 80).

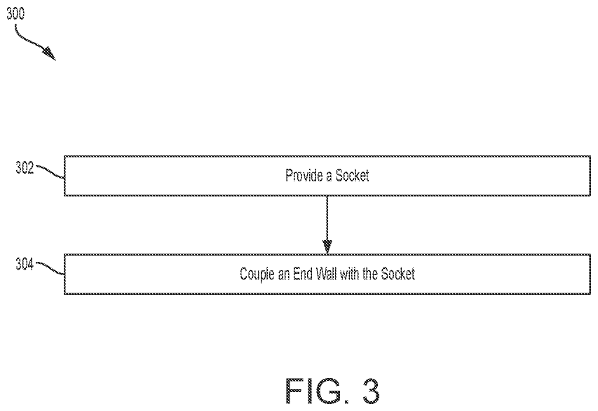

Referring now to FIG. 3, among others, a flow chart of a method of assembly of a cap pipe fitting 102 is shown. A method 300 can start at act 302 by providing a socket 202. The socket 202 can be produced by a number of manufacturing methods (e.g., injection molding, machining) and made of a number of possible materials (e.g., CPVC, PVC).

At act 304 of the method 300, an end wall 204 can be coupled to the socket 202. The end wall 204 can be coupled to the second end 226 of the socket 202 such that the socket 202 and end wall 204 are fused together (e.g., ultrasonic weld, chemical weld). The coupled socket 202 and end wall 204 can create a water tight seal that has the same material characteristics as the rest of the cap pipe fitting 102. As such, the coupling between the socket 202 and the end wall 204 does not provide an area for possible rupture when under pressure. The socket 202 and end wall 204 can be coupled using any suitable process (e.g., ultrasonic weld, chemical weld). The socket 202 and end wall 204 can be manufactured as a unitary component, as described herein.

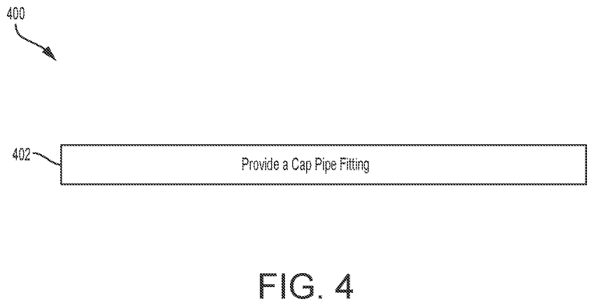

Referring now to FIG. 4, among others, a flow chart of a method of manufacture of a cap pipe fitting 102 is shown. The method 400 can start at act 402 where a cap pipe fitting 102 is provided. The cap pipe fitting 102 can be manufactured as a unitary component. The cap pipe fitting can be manufactured by any of a number of suitable methods (e.g., injection molding, machining).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A cap fitting, comprising:
a socket defining a first end and a second end, the first end being an opening, the first end having an edge between the first end and an internal surface of the socket, the socket having an outer diameter, a first wall thickness at the first end, and a second wall thickness at the second end, the second wall thickness greater than or equal to the first wall thickness; and
an end wall coupled with the second end of the socket, the end wall having a third wall thickness greater than or equal to the second wall thickness, the end wall having a concave shape such that there is a transition between the internal surface of the socket and an internal surface of the end wall.

2. The cap fitting of claim 1, comprising:
the transition between the internal surface of the socket and the internal surface of the end wall is linear.

3. The cap fitting of claim 1, comprising:
the edge of the first end is radiused.

4. The cap fitting of claim 1, comprising:
the internal surface of the socket having threads.

5. The cap fitting of claim 4, comprising:
a segment of pipe threaded into the internal surface of the socket.

6. The cap fitting of claim 4, comprising:
an external surface of the socket having a plurality of radially flat sections.

7. The cap fitting of claim 1, comprising:
the socket and the end wall are made from a plastic material.

8. The cap fitting of claim 1, comprising:
the first wall thickness is greater than or equal to 0.088 inches and less than or equal to 0.290 inches.

9. The cap fitting of claim 1, comprising:
the cap fitting is sized to withstand a burst pressure of 1440 psi.

10. The cap fitting of claim 1, comprising:
the cap fitting is sized to withstand a hydrostatic pressure cycling from 0 psi to 350 psi at a 6 second frequency for at least 10,000 cycles.

11. The cap fitting of claim 1, comprising:
the cap fitting is sized to standard schedule 40 dimensions.

12. The cap fitting of claim 1, comprising:
the cap fitting is sized to standard schedule 80 dimensions.

13. The cap fitting of claim 1, comprising:
the concave shape of the end wall is a semi-ellipse having a major axis to minor axis ratio between 1:1 and 3:1.

14. The cap fitting of claim 1, comprising:
a segment of pipe chemically welded to the internal surface of the socket.

15. A method of assembly of a cap pipe fitting, the method comprising:
providing a socket, the socket defining a first end and a second end, the first end being an opening, the socket having an outer diameter, a first wall thickness at the first end, and a second wall thickness at the second end, the second wall thickness greater than or equal to the first wall thickness; and
coupling an end wall with the second end of the socket, the end wall having a third wall thickness greater than or equal to the second wall thickness, the end wall having a concave shape such that there is a linear transition between an internal surface of the socket and an internal surface of the end wall.

16. The method of claim 15, comprising:
the end wall coupled with the second end of the socket by ultrasonic welding.

17. The method of claim 15, comprising:
the socket and the end wall are injection molded parts.

18. A method, comprising:
providing a cap pipe fitting, the cap pipe fitting comprising:
a socket defining a first end and a second end, the first end being an opening, the socket having an outer diameter, a first wall thickness at the first end, and a second wall thickness at the second end, the second wall thickness greater than or equal to the first wall thickness; and
an end wall coupled with the second end of the socket, the end wall having a third wall thickness greater than or equal to the second wall thickness, the end wall having a concave shape such that there is a linear transition between an internal surface of the socket and an internal surface of the end wall.

19. The method of claim 18, comprising:
the end wall having a semi-elliptical shape.

20. The method of claim 18, comprising:
the cap pipe fitting being injection molded.
